(19) United States
(12) Patent Application Publication
(10) Pub. No.: US 2008/0070691 A1
(43) Pub. Date: Mar. 20, 2008

(54) SYSTEM AND METHOD FOR TRIGGERING AN EVENT IN RELATION TO A COMPUTER TYPE GAME

(76) Inventors: David Christopher Hutchinson, Wamberal (AU); Coomar Chelia, Kirribilli (AU)

Correspondence Address: SCHWEGMAN, LUNDBERG & WOESSNER, P.A., P.O. BOX 2938, MINNEAPOLIS, MN, 55402, US

(21) Appl. No.: 11/760,176

(22) Filed: Jun. 8, 2007

(30) Foreign Application Priority Data
Jun. 9, 2006 (AU) 2006903129

(51) Int. Cl. G06F 17/00

(52) U.S. Cl. 463/42

(57) ABSTRACT

The present invention relates to a system and method of triggering an external event for a user of a computer type game. At least one computer type game platform is provided for supporting/running the computer type game, and the user is provided with a customization option within the computer type game. A customization code is sent by the user in response to the customization option, and the code is parsed to a messaging server. The external event is triggered by the messaging server communicating with an external communications device.

### RELATED APPLICATION

This application claims priority under 35 U.S.C. 119 to Australian Application No. 2006903129, filed Jun. 9, 2006, which application is incorporated herein by reference and made a part hereof.

### FIELD

Inventive subject matter relates to computer type games. More particularly, it concerns a system and method for triggering an event in relation to a computer type game, enhancing the interaction and gaming experience for a user.

### BACKGROUND

Recent improvements to computer type games include vibrating joysticks/controllers, and functional material that is included with the game packaging or sold as accompanying products (for example, a steering wheel for car racing games; an elaborate weapon for ‘shoot-em-up’ games, or a microphone for karaoke games).

Computer type games may be played on a variety of mediums/platforms, including personal computers, gaming consoles (such as Playstation®, or Xbox®), portable gaming units (such as Playstation Portable®, or Nintendo® Gameboy®), mobile phones, and the internet.

### SUMMARY OF THE INVENTION

According to a first aspect of the invention, there is provided a method of triggering an external event for a user of a computer type game, including:
providing at least one computer type game platform for supporting/running the computer type game;
providing the user with a customization option within the computer type game;
receiving a customization code from the user in response to the customization option; and
parsing the customization code to a messaging server;
wherein the external event is triggered by the messaging server communicating with an external communications device.

According to another aspect of the invention, the platform is a personal computer connected to a network server or the internet. The platform may also exist as a gaming console configured for external communication.

In accordance with a further aspect of the invention, there is provided a method of triggering an event for a computer type game, including the steps of:
providing at least one computer type game server/platform for supporting/running the computer type game;
presenting to a user at least one customization option within the computer type game, wherein each customization option includes an event prompt;
receiving a customization code from the user in response to the at least one customization option;
evaluating the customization code to determine if an event prompt has been accessed;
wherein the event is triggered on the at least one game server/platform in response to the event prompt being accessed.

According to another aspect of the invention, the event is independent of the game play.

In yet another aspect of the invention, there is provided a method of communicating with a user of a computer type game via a user's remote communications device, including the steps of;
providing at least one computer type game server/platform for supporting/running the computer type game, wherein the server/platform includes a messaging server;
presenting to the user at least one customization option within the computer type game, wherein each customization option includes an event prompt;
receiving a customization code from the user in response to the at least one customization option;
evaluating the customization code to determine if an event prompt has been activated;
wherein communication with the user's remote communications device occurs through the messaging server in response to the activation of the event prompt.

According to another aspect of the invention, the user's remote communications device is a mobile phone utilising a wireless network.

In accordance with a further aspect of the invention, there is provided a system enabled to perform and support the above described methods.

The disclosed methods and systems include a combination of features and advantages which enable the inventive subject matter described herein to be an advantageous alternative to the prior art. The various characteristics described above, as well as other features, will be readily apparent to those skilled in the art upon reading the following detailed description, and by referring to the accompanying figures.

### BRIEF DESCRIPTION OF THE DRAWINGS

The invention will now be described in a non-limiting manner with respect to a preferred embodiment in which:—

FIG. 1 is a block diagram of a method according to an embodiment of the present invention.

FIG. 2 is a block diagram of a method according to an alternative embodiment of the current invention.

### DETAILED DESCRIPTION OF PREFERRED EMBODIMENTS

In the following discussion and in the claims that follow, the term “including” and “includes” are used, and are to be read, in an open-ended fashion, and should be interpreted to mean “including, but not limited to . . . ”.

The term “computer type game” is to be given a broad meaning and refers to a game or leisure activity that is supported on an electronic platform. Computer type game examples may include 1^{st} person, 3^{rd} person, adventure, strategy, arcade style, platform, puzzle or roll playing type games.

The term “platform” is to be given a broad meaning and refers to electronic medium capable of running/supporting application programs. This term may include at least one personal computer, gaming console, mobile device, arcade game, home entertainment system, television satellite or terrestrial tuner, and may be IP enabled.

Computer type games are extremely popular, and software developers have constantly looked to improve the interaction with the user. Such improvements aim to enhance the user's experience of the gaming arena, to give an edge in marketing and increase sales. That is, computer type game improvements attempt to give the user a real life experience whilst in game-play.

The user's enhanced experience or interaction with the game is limited by the software and the gaming platform. Elaborate accompaniments can be costly and incompatible across varying platforms.

Inventive subject matter described herein advantageously provides an alternative to a user's interaction with a computer type game. The system and method according to certain embodiments of the invention may advantageously be used to enhance a user's experience of the computer type game.

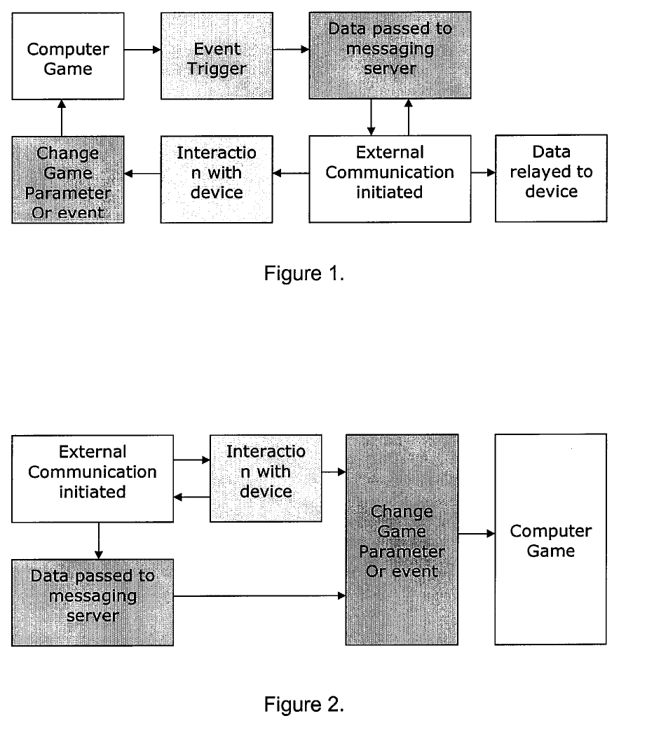

An embodiment of the present invention is shown in FIG. 1. The user of a computer type game may trigger an event in relation to the game in a number of ways. For example, the user may:
Go to a particular point, location or region in the game;
Interact with an object, game character or feature;
Enter specific keywords or control sequences;
‘Stumble’ across game manufacturer defined events; and/or
Participate in time based events.

Such instances are referred to as event prompts. Event prompts may be embedded in customization options that allow interaction with the computer type game, and require a decision from the user.

The user may respond to the event prompt depending on game strategy, and the attractiveness of the customization option. An example of a user's response may simply be a specific combination of game character movements controlled by a user's control pad or joystick. Further examples are discussed below. The response is referred to as a customization code, and is parsed to a messaging server. The messaging server then initiates external data communication with the user's communications device or medium, such as SMS, fax, voice, text-to-speech, IVR, e-mail, Voice over IP or similar, as well as combinations thereof, in accordance with the customization code.

The user of the computer type game may respond to the received communication and alter a parameter of the game.

Conversely the user of the computer type game may initiate an electronic data communication from an external source (such as fax, SMS, e-mail, voice, IVR etc.) whilst inside/playing the game as shown in FIG. 2. Such communication can trigger a wide variety of events within the game itself, thus invoking a modification to the game experience.

The following examples illustrate the methods and systems of the present invention:
Ex. i) In the scenario of a ‘shoot-em-up’ game, the user travels past a poster within the game advertising a Cola drink. The poster represents a customization option. By shooting the poster (or a given region within) for example, the user is responding with a customization code and is given instructions to send a text (SMS) message or codeword to a given number. The game user is then provided with a special feature (commonly referred to as an ‘Easter Egg’) within the game such as access to a new weapon, area or map region, unlock health or ability.
Ex. ii) In the scenario of a 1^{st} person game a player may enter a building or structure such as a pizza restaurant, and by interacting with a virtual menu or character acting as a customization option, the user triggers an external event and may be connected automatically by the messaging server via a VoIP (Voice over IP) headset for example, directly to a pizza restaurant nearest their physical location to place an order, without having to leave the game. If the user does not have a VoIP headset then a phone call can be placed to the user's mobile or fixed telephone and joined or switched to the pizza restaurant.
Ex. iii) In the scenario of a driving or racing game, the user may drive their vehicle into the garage or showroom of a virtual dealership. The garage or showroom of a virtual dealership is the customization option, and the act of the user driving the vehicle into this location is the customization code. This action triggers an external event prompting a message to the user via voice or text-to-speech message to the user's mobile or fixed telephone inviting them to test drive a new car. The phone call could also include using IVR (Interactive Voice Response) to connect the user directly to a dealership in order to book the test drive, for example.
Ex. iv) In the scenario of an adventure game, the user may be prompted to utilize their telephone to interact with the game and trigger an event that sends hidden/secret messages or simply sends a message in the voice of a character to expand the atmosphere and experience of the game play. The received messages at the user's communications device may utilise IVR to lead the user through a series of game related options and may further be integrated with other mediums such as facsimile, where the user can enter their fax number in order to receive maps, clues, instructions or other game-related material.
Ex. v) In the scenario of a puzzle game the user may be invited to use a chosen device, such as their cell phone, to trigger an external event that sends clues, game hints, cheats or access to new game areas.

In all of the above examples, identification information is collected at the time of game installation or via a separate opt-in registration process. This information can be held on a database or data file on the users PC or on an external data server, which can be accessed subsequently by the messaging server in order to determine, facilitate and/or validate the external communications processes described.

Examples of the required user's information may be the user's name, telephone number, fax number, mobile phone number, zip code, country, age, sex, purchasing preferences, interests, product license code or license key, and serial numbers.

The user's age can be used to decide whether a given type of content or product (such as a car test drive described in Example iii above) would be appropriate. A user's zip code or postcode can be used to determine their nearest location for food delivery services, car test drives or legality of services in the user's jurisdiction. Further, a user's sex could be used to determine the types of products or services that may be of interest or applicable to the user. Combinations of data can be used in more complex decision making.

The interaction or experience of integrating external messaging may be enhanced with the incorporation of product/service brands for the purposes of marketing, awareness creation, sponsorship or advertising.

Furthermore, whenever external communications are responded to by the user, data can be collected and collated to determine trends, preferences and usage patterns, for example, which can thereafter be used for marketing purposes, game modifications, product placements, brand awareness, planning and advertising or other constructive use of the collected data.

It is to be understood that the above embodiments have been provided only by way of exemplification of this invention, and that further modifications and improvements thereto, as would be apparent to persons skilled in the relevant art, are deemed to fall within the broad scope and ambit of the current invention described and claimed herein.

What is claimed is:

1. A method of triggering an external event for a user of a computer type game, including the steps of:
providing at least one computer type game platform for supporting the computer type game;
providing the user with a customization option within the computer type game;
receiving a customization code from the user in response to the customization option; and
parsing the customization code to a messaging server;
wherein the external event is triggered by the messaging server communicating with an external communications device.

2. The method according to claim 1, wherein the game platform is a personal computer connected to a network server or the internet.

3. The method according to claim 1, wherein the platform is a gaming console configured for external communication.

4. The method according to claim 1, wherein the messaging server includes a database consisting of a user's identification information.

5. The method according to claim 1, wherein the external communications device is a user's cell phone or facsimile.

6. The method according to claim 1, wherein the customization code received from the user is a SMS or voice communication.

7. A method of triggering an event in a computer type game, including:
providing at least one computer type game platform for supporting the computer type game;
presenting to a user at least one customization option within the computer type game, wherein each customization option includes at least one event prompt;
receiving a customization code from the user in response to the at least one customization option;
evaluating the customization code to determine if at least one event prompt has been accessed;
wherein the event is triggered on the at least one game platform in response to the event prompt being accessed.

8. The method of triggering an event in a computer type game according to claim 7, wherein the computer type game platform includes a messaging server configured for external communication.

9. The method of triggering an event in a computer type game according to claim 8, wherein the game platform is a personal computer connected to a network server or the internet.

10. The method of triggering an event in a computer type game according to claim 8, wherein the messaging server includes a database consisting of a user's identification information.

11. The method of triggering an event in a computer type game according to claim 10, wherein the event is an external event consisting of sending a data or voice message to a user's communications device through the message server.

12. A method of communicating with a user of a computer type game via a user's remote communications device, comprising:
providing at least one computer type game platform for supporting the computer type game, wherein the platform includes a messaging server;
presenting to a user at least one customization option within the computer type game, wherein each customization option includes an event prompt;
receiving a customization code from the user in response to the at least one customization option;
evaluating the customization code to determine if an event prompt has been activated;
wherein communication with the user's remote communications device occurs through the messaging server in response to the activation of the event prompt.

13. A system including logic stored on a computer readable medium for performing the method according to claim 7.

14. A system including logic stored on a computer readable medium for performing the method according to claim 12.
